(19) United States
(12) Patent Application Publication
(10) Pub. No.: US 2020/0205095 A1
(43) Pub. Date: Jun. 25, 2020

(54) NETWORK NODE, WIRELESS COMMUNICATION DEVICE, METHODS AND COMPUTER PROGRAMS

(71) Applicant: Telefonaktiebolaget LM Ericsson (publ), Stockholm (SE)

(72) Inventors: Magnus ÅSTRÖM, Lund (SE); Andres REIAL, Malmö (SE); Johan RUNE, Lidingö (SE)

(21) Appl. No.: 15/752,849

(22) PCT Filed: Dec. 13, 2017
(86) PCT No.: PCT/EP2017/082650

§ 371 Date: Feb. 14, 2018

Related U.S. Application Data
(60) Provisional application No. 62/475,539, filed on Mar. 23, 2017.

(51) Int. Cl. H04W 56/00; H04J 11/00; H04W 48/12

(52) U.S. Cl. CPC H04W 56/001; H04J 11/0073; H04W 48/12; H04J 11/0079; H04J 11/0076

(57) ABSTRACT

Methods in a network node and a wireless communication device of a cellular communication system, wherein the cellular communication system is constructively arranged for co-existence of multiple network access signalling configurations, are provided. The network node method comprises collecting information about a network access signalling configuration, selecting a low autocorrelation sequence based on the network access signalling configuration, forming a synchronisation signal based on the low autocorrelation sequence, and transmitting the synchronisation signal as a part of a system network access signalling transmission. The wireless communication device method comprises receiving a synchronisation signal, determining, from a sequence of the synchronisation signal, information about synchronisation and a network access signalling configuration, and adapting reception of further signals to the determined network access signalling configuration. A network node, wireless communication device and computer programs therefor are also disclosed.

### TECHNICAL FIELD

The present disclosure generally relates to methods of a network node and a wireless communication device, respectively, and to such network node and such wireless communication device, and computer programs for them to implement the methods.

### BACKGROUND

In order to connect to a wireless communication network, a device needs to acquire network synchronisation. This is for adjusting the frequency of the device relative the network, and for finding the proper timing of the received signal from the network.

In legacy cellular communication systems, such as the Long Term Evolution (LTE), cell synchronisation is the very first step when the wireless communication device, referred to as user equipment (UE), wants to camp on a cell. From this, the UE acquires physical cell identity (PCI), time slot and frame synchronisation, which will enable the UE to read system information blocks from a particular network. The UE will tune its radio by turning to different frequency channels depending upon which bands it is supporting. The UE is supposed to first find a primary synchronisation signal (PSS) which in the legacy system is located in a last OFDM symbol of a first time slot of a first subframe (subframe 0) of a radio frame. This enables the UE to be synchronised on subframe level. The PSS is in the legacy system repeated in subframe 5, which means that the UE is synchronised on 5 ms basis since each subframe is 1 ms. From the PSS, the UE is also able to obtain a physical layer identity (0 to 2). In the next step, the UE finds a secondary synchronisation signal (SSS). SSS symbols are in the legacy system also located in the same subframe as the PSS but in the symbol before the PSS. From the SSS, the UE is able to obtain a physical layer cell identity group number (0 to 167). Using the physical layer identity and the cell identity group number, the UE is now able to know the PCI for this cell. In LTE, 504 physical layer cell identities are allowed and are divided into unique 168 cell layer identity groups where each group consist of three physical layer identity. As mentioned earlier, the UE detects physical layer identity from the PSS and physical layer cell identity group from the SSS. Once the UE knows the PCI for a given cell, it also knows the location of cell reference signals, which are used in channel estimation, cell selection/reselection and handover procedures.

Thus, this legacy system, i.e. in LTE, utilizes three sequences of the primary synchronisation signal (PSS), which together with the subsequent secondary synchronisation signal (SSS) allow the UE to properly and efficiently determine the Physical Cell Identity (PCI) of the transmitting cell. In particular, the time/frequency (T/F) synchronisation obtained from time domain detection of PSS allows SSS to be detected efficiently in the frequency domain. This is a viable solution in many single purpose networks such as LTE. LTE was mainly designed for providing Mobile Broadband (MBB) services to data intensive smartphones, tablets and laptops. Thus, the need for network configurability is, somewhat simplified, limited to network bandwidth, and PCI, in order for a UE to distinguish between different cells. For example, most broadcast signalling is standardized to be located in central 6 resource blocks.

In coming cellular communication systems, more flexibility is demanded, and the rather straightforward rules as demonstrated for the legacy system above may not be feasible. For a radio access technology (RAT) aimed at more diverse usage scenarios, such as the New Radio (NR) which is a part of a 5^{th} generation (5G) system currently being standardized by 3^{rd} Generation Partnership Project (3GPP), it may be desirable to support a more flexible network configuration. For example, NR will be used in a much wider range of applications than LTE. For example, also specialized NR networks, e.g., local, low latency factory networks or vehicular support networks, may co-exist with a wide area network (WAN) providing mobile broadband coverage. However, the different networks may require very different initial access configuration features to perform optimally. Hence, there is a need for provisioning of different initial access configuration features in a network in order to better serve a wide variety of wireless devices and applications. However, in addition to the problematic lack of access configuration features suitable for diverse scenarios, mixing multiple different initial access configuration features in a network in itself poses a problem, as it significantly complicates the initial access procedures for the wireless devices by forcing them to perform blind detection of the different configurations by tentatively performing multiple candidate access procedures.

It is therefore desired to alleviate effects of initial access procedures in such flexible system.

### SUMMARY

The disclosure is based on the finding that providing an indication on network access signalling configuration in an early part of synchronisation procedure will facilitate for the wireless communication device to take appropriate actions directly without extensive efforts with blind detection.

According to a first aspect, there is provided a method in a network node of a cellular communication system, wherein the cellular communication system is constructively arranged for co-existence of multiple network access signalling configurations. The method comprises collecting information about a network access signalling configuration, selecting a low autocorrelation sequence based on the network access signalling configuration, forming a synchronisation signal based on the low autocorrelation sequence, and transmitting the synchronisation signal as a part of a system network access signalling transmission.

The information about the network access signalling configuration may comprise information enabling a wireless device to access the network node and/or the cellular communication system.

The network access signalling configuration may comprise configuration of one or more synchronisation signals.

The synchronisation signal may be constructively configured to convey system information by being based on the information about the network access signalling configuration.

The system network access signalling transmission may comprise a synchronisation signal block, SSB. The synchronisation signal may form a primary synchronisation signal, PSS, of the SSB which further may comprise any one of a secondary synchronisation signal, SSS, a tertiary synchronisation signal, TSS, and a physical broadcast channel, PBCH, signal. Additional information about a network configuration may be provided in a master information block, MIB, holding the network configuration, wherein the sequence selected for the PSS may include information about allocation of the MIB. The sequence selected for the PSS may include information about at least one of configuration of the SSS, TSS and the PBCH in relation to the PSS, configuration of the PBCH, configuration of system information on a physical downlink shared channel, PDSCH_{SIB}, configuration of another channel carrying system information such as for example a channel providing scheduling information about a channel providing system information, e.g. physical downlink control channel PDCCH_{SIB} carrying scheduling information about the PDSCH_{SIB}, allocation of transmission resources for the another channel carrying system information, indication of whether different instances of synchronisation signal transmissions may be soft-combined, further SSB parameters, quasi-co-location of transmission points of the PSS and other parts of the SSB, TSS allocation related to the PSS, SSB transmissions which may include whether the SSB is transmitted in a beam with a first width and repeated in time or in a beam with a second width and swept over multiple directions, wherein the first width is wider than the second width, bandwidth of SSB, time division properties of SSB, and frequency division properties of SSB.

According to a second aspect, there is provided a network node arranged to operate in a cellular communication system, wherein the cellular communication system is constructively arranged for co-existence of multiple network access signalling configurations. The network node comprises a controller and a transceiver. The controller is arranged to collect information about a network access signalling configuration, select a low autocorrelation sequence based on the network access signalling configuration, and form a synchronisation signal based on the low autocorrelation sequence. The transceiver is arranged to transmit the synchronisation signal as a part of a system network access signalling transmission.

The information about the network access signalling configuration may comprise information enabling a wireless device to access the network node and/or the cellular communication system.

The network access signalling configuration may comprise a configuration of one or more synchronisation signals.

The synchronisation signal may be constructively configured to convey system information by being based on the information about the network access signalling configuration.

The system network access signalling transmission may comprise a synchronisation signal block, SSB. The synchronisation signal comprises a primary synchronisation signal, PSS, of the SSB which further may comprise any one of a secondary synchronisation signal, SSS, a tertiary synchronisation signal, TSS, and a physical broadcast channel, PBCH, signal. Additional information about a network configuration may be provided in a master information block, MIB, holding the network configuration, wherein the sequence selected for the PSS may include information about allocation of the MIB. The sequence selected for the PSS may include information about at least one of configuration of the SSS and the PBCH in relation to the PSS, configuration of the PBCH, configuration of system information on a physical downlink shared channel, PDSCH_{SIB}, configuration of another channel carrying system information, allocation of transmission resources for the another channel carrying system information, indication of whether different instances of synchronisation signal transmissions may be soft-combined, further SSB parameters, quasi-co-location of transmission points of the PSS and other parts of the SSB, TSS allocation related to the PSS, SSB transmissions which may include whether the SSB is transmitted in a beam with a first width and repeated in time or in a beam with a second width and swept over multiple directions, wherein the first width is wider than the second width, bandwidth of SSB, time division properties of SSB, and frequency division properties of SSB.

According to a third aspect, there is provided a computer program comprising instructions which, when executed on a processor of a network node, causes the network node to perform the method according to the first aspect.

According to a fourth aspect, there is provided a method of a wireless communication device arranged to operate in a cellular communication network, wherein the cellular communication system is constructively arranged for co-existence of multiple network access signalling configurations. The method comprises receiving a synchronisation signal, determining, from a sequence of the synchronisation signal, information about synchronisation and a network access signalling configuration, and adapting reception of further signals to the determined network access signalling configuration.

The adapting of the reception may comprise at least one of adapting receiver bandwidth, adapting reception window, adapting receiver frequency, adapting transform properties of a receiver, adapting averaging of received signals, adapting antenna port use of the receiver, and adapting resource mapping of subsequent signals and channels, including at least one of time, frequency, polarization, cyclic shift and code resources.

The sequence may be a low autocorrelation sequence.

The information about the network access signalling configuration may comprise information enabling the wireless communication device to access a network node and/or the cellular communication system.

The network access signalling configuration may comprise configuration of one or more synchronisation signals.

The synchronisation signal may be constructively configured to convey system information by being based on the network access signalling configuration.

The synchronisation signal may be a primary synchronisation signal, PSS, of a synchronisation signal block, SSB. The SSB may further comprise any one of a secondary synchronisation signal, SSS, a tertiary synchronisation signal, TSS, and a physical broadcast channel, PBCH, signal.

The information about the network access signalling configuration may include information about at least one of configuration of the SSS and the PBCH in relation to the PSS, configuration of the PBCH, configuration of system information on a physical downlink shared channel, PDSCH_{SIB}, configuration of another channel carrying system information, allocation of transmission resources for the another channel carrying system information, indication of whether different instances of synchronisation signal transmissions may be soft-combined, further SSB parameters, quasi-co-location of transmission points of the PSS and other parts of the SSB, TSS allocation related to the PSS, SSB transmissions, including whether the SSB is transmitted in a beam with a first width and repeated in time or in a beam with a second width and swept over multiple directions, wherein the first width is wider than the second width, operation in licensed or unlicensed band, bandwidth of SSB, time division properties of SSB, and frequency division properties of SSB.

According to a fifth aspect, there is provided a wireless communication device arranged to operate in a cellular communication network, wherein the cellular communication system is constructively arranged for co-existence of multiple network access signalling configurations. The wireless communication device comprises a transceiver and a controller. The transceiver is arranged to receive a synchronisation signal. The controller is arranged to determine, from a sequence of the synchronisation signal, information about synchronisation and a network access signalling configuration, and adapt reception of further signals to the determined network access signalling configuration.

The adaptation of the reception may comprise at least one of adaptation of receiver bandwidth, adaptation of reception window, adaptation of receiver frequency, adaptation of transform properties of a receiver, adaptation of averaging of received signals, adaptation of antenna port use of the receiver, and adaptation of resource mapping of subsequent signals and channels, which may include at least one of time, frequency, polarization, cyclic shift and code resources.

The sequence may be a low autocorrelation sequence.

The information about the network access signalling configuration may comprise information enabling the wireless communication device to access a network node and/or the cellular communication system.

The network access signalling configuration may comprise configuration of one or more synchronisation signals.

The synchronisation signal may be constructively configured to convey system information by being based on the network access signalling configuration.

The synchronisation signal may be a primary synchronisation signal, PSS, of a synchronisation signal block, SSB. The SSB may further comprise any one of a secondary synchronisation signal, SSS, a tertiary synchronisation signal, TSS, and a physical broadcast channel, PBCH, signal.

The information about the network access signalling configuration may include information about at least one of configuration of the SSS and the PBCH in relation to the PSS, configuration of the PBCH, configuration of system information on a physical downlink shared channel, PDSCH_{SIB}, configuration of another channel carrying system information, allocation of transmission resources for the another channel carrying system information, indication of whether different instances of synchronisation signal transmissions may be soft-combined, further SSB parameters, quasi-co-location of transmission points of the PSS and other parts of the SSB, TSS allocation related to the PSS, SSB transmissions, including whether the SSB is transmitted in a beam with a first width and repeated in time or in a beam with a second width and swept over multiple directions, wherein the first width is wider than the second width, operation in licensed or unlicensed band, bandwidth of SSB, time division properties of SSB, and frequency division properties of SSB.

According to a sixth aspect, there is provided a computer program comprising instructions which, when executed on a processor of a wireless communication device, causes the wireless communication device to perform the method according to the fourth aspect.

### BRIEF DESCRIPTION OF THE DRAWINGS

The above, as well as additional objects, features and advantages of the present disclosure, will be better understood through the following illustrative and non-limiting detailed description of preferred embodiments of the present disclosure, with reference to the appended drawings.

FIG. 1 schematically illustrates an example of a synchronisation signal block (SSB).

FIG. 2 is a time-frequency diagram illustrating distribution of SSBs.

FIG. 3 illustrates timing diagrams for synchronisation signal bursts and burst sets.

FIG. 4 is a flow chart illustrating a method of a network node according to an embodiment.

FIG. 5 is a flow chart illustrating a method of a wireless communication device according to an embodiment.

FIG. 6 illustrates different SSB configurations according to an embodiment.

FIG. 7 illustrates different system information configurations according to an embodiment.

FIG. 8 is a block diagram schematically illustrating a wireless communication device according to an embodiment.

FIG. 9 schematically illustrates a computer-readable medium and a processing device for a wireless communication device.

FIG. 10 schematically illustrates a computer-readable medium and a processing device for a network node.

FIG. 11 illustrates parts of a cellular communication network including network nodes and a wireless device.

### DETAILED DESCRIPTION

In New Radio (NR) (part of the 5G system currently being standardized by 3GPP), the synchronisation procedure will be performed using several signals:

Primary synchronisation signal (PSS) that allows for network detection with a high frequency error, up to tens of ppm. Additionally, PSS provides a network timing reference. 3GPP has selected Zadoff-Chu (ZC) sequences as PSS signals. One interesting property of these are that by careful selection of two ZC sequences, the same correlation sequence may be used for detection, adding negligible complexity.

Other sequences with low autocorrelation, e.g. pseudo-random sequences, may be used as well in the approach suggested in this disclosure. For example, polyphase sequences or other sequences with low autocorrelation such as the Barker sequence, maximum length sequence (m-sequence), etc., as well as other constant amplitude zero autocorrelation (CAZAC) sequences than the ZC sequence.

Secondary synchronisation signal (SSS) that allows for more accurate frequency adjustments and channel estimation while at the same time providing fundamental network information in the form of a locally unique cell identity (also referred to as the Physical Cell Identity, PCI).

Tertiary synchronisation signal (TSS) that provides timing information within a cell, e.g. between beams transmitted in a cell.

Physical broadcast channel (PBCH) that provides a subset of the minimum system information for random access (sometimes referred to as Master Information Block, MIB).

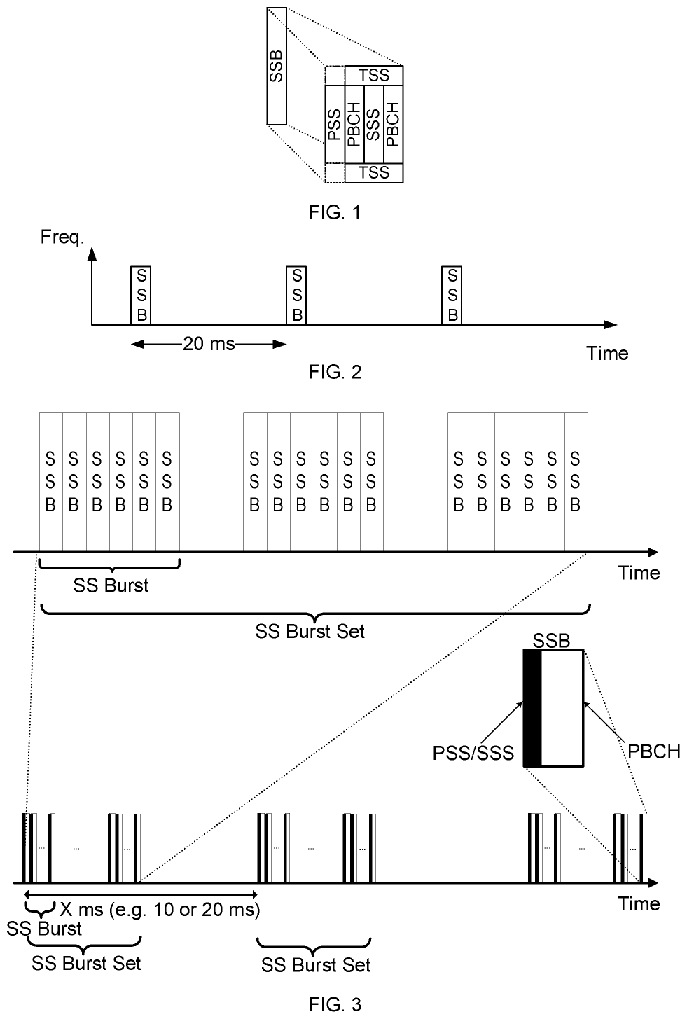

A synchronisation signal block (SSB) comprises the above signals. FIG. 1 schematically illustrates one possible structure of an SSB. FIG. 2 is a time/frequency diagram which illustrates an example on repeated transmission of the SSB. In FIG. 2, it is illustrated that the SSB periodicity may be 20 ms, but can be sent with another periodicity, e.g. 10 ms, 40 ms, 80 ms or the like. Here, it can be noted that the periodicity of the SSB may be one parameter which is indicated by a network access signalling configuration information as demonstrated below. In brief, the network access signalling configuration means the time, frequency, beam, format, encoding, etc. which is used for signals used for providing access to the network.

Here, the information about the network access signalling configuration provided by the sequence selection of the initial synchronisation signal may not provide all information about the network access signalling configuration, but enough information such that the wireless communication device need not do a completely blind search and is facilitated to find further signalling, e.g. further synchronisation signals, where more information about network access signalling configuration may be given, as well as other network configuration parameters. Thus, the selection of sequence demonstrated below may be made from a subset of parameters of the network access signalling configuration. This will be easier understood from examples given below.

It can also be noted that the illustrated SSB has a certain bandwidth coverage, as illustrated by the extension along the frequency axis. The SSB bandwidth may be fixed for respective used frequency band, e.g. 4.32 MHz for carrier frequencies below 6 GHz and a higher bandwidth for carrier frequencies above 6 GHz. The configuration of this may also be indicated by the network access signalling configuration information demonstrated below.

A physical downlink shared channel (PDSCH) may provide remaining parts of the system information (PDSCH_{SIB}). PDSCH_{SIB} may be transmitted in resources indicated by PBCH, or in a resource indicated by PDCCH_{SIB}, which in turn is indicated by the PBCH.

Depending on the deployment, beamforming may be used to distribute the SSB over the network (NW) coverage area. Multiple SSBs are then aggregated to form an SSB burst where each SSB instance is beamformed in a certain direction, either to ensure coverage or to provide beam finding support for subsequent link establishment.

As mentioned above, for the purpose of improving coverage (or beam finding), the SSB may be transmitted using beamforming in the form of a beam sweep including multiple beams which together cover the desired area. Another means for improving coverage is repetition of wide (even omni-directional) beam transmissions. Both beam sweeping and repetition involves multiple transmissions. A number of SSB transmissions may be lumped together, i.e. transmitted in a tight series, denoted synchronisation signal bursts (SS Burst). A “SS Burst Set” may also be formed, where a SS Burst Set is a set of SS Bursts, typically with some non-zero interval between successive SS Burst transmissions as illustrated in FIG. 3. A SS Burst may for instance consist of the beam transmissions of a full beam sweep. However, there may also be reasons for not including a full beam sweep in a SS Burst, for instance if the number of beams in the sweep is comparably high and a full beam sweep would take longer time than allowed or desired for a SS Burst. In such a case, the beam sweep may be divided into multiple SS Burst, e.g. forming a SS Burst Set. In any case, the recurrence interval of the same beam in a sweep is preferably fixed, irrespective of whether the SS Burst Set consists of multiple or a single SS Burst. This fixed recurrence interval may for example be 10 ms or 20 ms.

The network access signalling configuration choices may for example be affected by carrier bandwidth, ultra-reliable low latency communication (URLLC) and Internet of Things (IoT) support, quality of service (QoS), e.g. latency, requirements, etc.

In this disclosure it is suggested to convey limited fundamental network access signalling configuration information by using different sequences of the PSS. In short, the network node, e.g. gNB, determines its network access signalling configuration with respect to one or more critical configuration parameters, selects a PSS sequence that has been previously agreed to refer to the determined configuration, and transmits it in the assigned PSS T/F resources. The wireless communication device, e.g. UE, detects the PSS sequence, determines the encoded configuration parameters, and performs the rest of the access procedure according to the determined configuration.

The cellular communication system is constructively arranged for co-existence of multiple network access signalling configurations. That is, the specifications for the cellular communication system allows more than one configuration for at least some signalling, e.g. synchronisation and system information signalling. The cellular communication system may benefit from this by providing more flexibility such as different amount of overhead for different needs/demands of provided services. The co-existence of multiple network access signalling configurations may for example comprise that multiple network access signal configurations co-exist in the same cell, e.g. the co-existence of multiple network access signal configurations in the same cell is realized by using different network access signalling configurations at different times in the cell. In another example, the co-existence of multiple network access signalling configurations may comprise that multiple network access signal configurations co-exist in the same network, e.g. the co-existence of multiple network access signalling configurations in the same network comprises that each cell uses a single network access signalling configuration, but at least one cell in the network uses another network access signalling configuration than another cell in the network. A further example may be that the co-existence of multiple network access signal configurations comprises that multiple network access signalling configurations co-exist in different networks, e.g. the co-existence of multiple network access signal configurations in different networks comprises that each of two or more networks uses a single network access signalling configuration, but at least one network of the two or more networks uses another network access signalling configuration than another network of the two or more networks.

The suggested approach thus enables increased flexibility for NW configuration according to the usage scenario, without unduly extending the UE's processing load associated with blindly detecting the different configurations by tentatively performing multiple candidate access procedures.

The suggested approach includes a method in a network node to transmit a network configuration indicator by using one out of several PSS sequences that correspond to different configurations. Hence, the disclosure leverages this lack of connection between the PSS and the PCI in for example NR to let the PSS provide means for enabling smooth coexistence of multiple initial access configuration features in a network as well as in different networks, thereby allowing a variety of wireless devices, which may be running a variety of applications with a variety of requirements, to access the network using access configuration features which are particularly suitable for the special requirements of the wireless communication device.

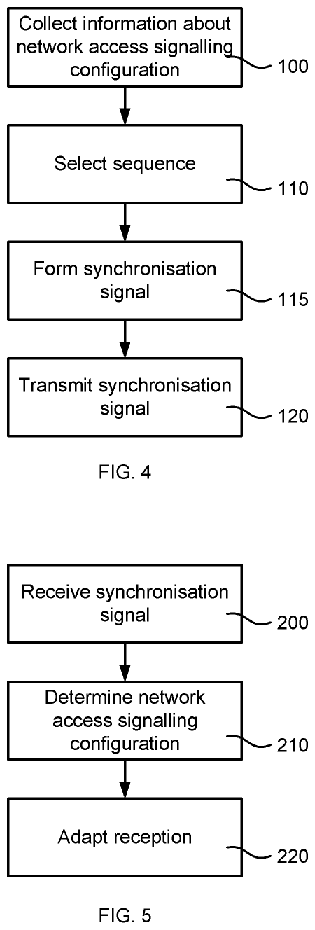

FIG. 4 is a flow chart schematically illustrating a method of a network node, e.g. a gNB. To this end, the solution starts by identifying 100 the present gNB configuration, that is, collects 100 information about a network access signalling configuration. This may be done by reading a configurations file or acquiring the current NW configuration information by some other way, e.g. receiving it from an entity in an operation and maintenance system. From this configuration information, the network node maps 110 the identified configuration to a corresponding PSS sequence, that is, selects 110 a low autocorrelation sequence based on the network access signalling configuration and forms 115 a synchronisation signal based on the low autocorrelation sequence. The selection of the sequence may include selecting a root index for the sequence. Finally, the network node transmits 120 the selected PSS sequence, i.e. transmits 120 the synchronisation signal in a synchronisation signal block, SSB, whereby any UE receiving the PSS will also know the gNB configuration. Note that the PSS sequence may also itself be part of the above-mentioned configuration information.

FIG. 5 is a flow chart schematically illustrating a method of a wireless communication device, e.g. a UE. Thus, the corresponding method at the UE side comprises searching 200 the received signal for several possible predetermined PSS sequences, i.e. receiving 200 a synchronisation signal, detecting one of these sequences, determining 210 the NW configuration that the PSS corresponds to, i.e. determining 210, from a sequence of the synchronisation signal, information about synchronisation and a network access signalling configuration, and adapting 220 reception of further signals to the determined network access signalling configuration, i.e. configuring 220 its access procedure sequence according to the determined NW configuration, and performing the rest of the access procedure accordingly.

The adapting 220 of the reception may for example comprise at least one of adapting receiver bandwidth, adapting reception window, adapting receiver frequency, adapting transform properties of a receiver, adapting averaging of received signals, adapting antenna port use of the receiver, and adapting resource mapping of subsequent signals and channels. The adapting of resource mapping of subsequent signals and channels may include at least one of time, frequency, polarization, cyclic shift and code resources. The adapting of the reception window may for example comprise applying a shorter reception window when PDSCH_{SIB} is frequency division multiplexed with SSB and applying a longer reception window when PDSCH_{SIB} is time division multiplexed with SSB.

The interpretation of the configuration—or configuration indication—may depend on external factors, e.g., carrier frequency, licensed/unlicensed operation, etc. For example, for an unlicensed band, a certain PSS sequence may imply one configuration, whereas in a licensed band the same PSS sequence means something else.

The number of distinct NW access signalling configurations that can be signalled this way equals the number of PSS sequence candidates. As described above, this may be turned into more configurations by letting other circumstances impact the interpretation of the PSS sequence. It is expected that the number will be kept low to keep the processing load low for UEs performing the time domain search for the PSS. A reasonable expected number of sequences may be e.g. 2, 3, or 4, but probably not exceeding 8 for enabling slim implementation in UEs, as discussed above.

Several alternatives exist for which types of network configurations may be conveyed through the PSS.

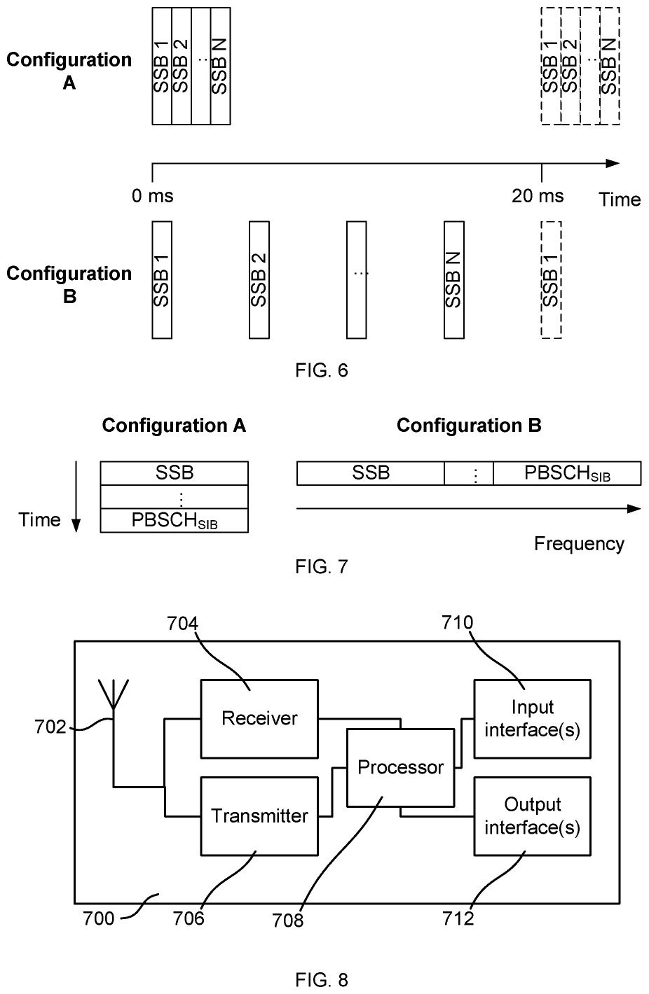

In one embodiment, it may be the configuration of SSBs, e.g. in a time-frequency grid, such that the UE may find out about which averaging strategies it may use for further decoding of the SSS, TSS, PBCH etc. FIG. 6 illustrates two different configurations: Configuration A and Configuration B. Note that the denotation Configuration A and Configuration B is only used for distinguishing the two examples, and the illustrations of respective configurations are simplified for easier understanding of the principles. Here, Configuration A may be suitable for a wide beam SSB transmission such that a UE may perform coherent combining of subsequent SSBs and thereby be able to properly decode the signals. The sooner a UE knows an averaging pattern, the more and the earlier the signals may be averaged and thereby contribute to the improved reception. FIG. 7 illustrates another embodiment which involves signalling the configuration of PDSCH_{SIB} in relation to the SSB. Also, here the denotation Configuration A and Configuration B is only used for distinguishing the two examples, and the illustrations of respective configurations are simplified for easier understanding of the principles. Here, in Configuration A an SSB and a PBSCH_{SIB} are transmitted in a time division multiplexing (TDM) fashion, whereas in Configuration B they are transmitted in a frequency division multiplexing (FDM) fashion. The advantages of either configuration may e.g., be that for example a 5 MHz channel may only allow for Configuration A whereas a more efficient synchronisation or a faster beam sweep as well as faster and more energy efficient reception may be performed with Configuration B assuming that sufficient network bandwidth exists. Configuration A may also be favourable in networks with abundant spectrum bandwidth (e.g. a bandwidth which could accommodate Configuration B), in order to allow access to narrowband UEs, i.e. UEs which are restricted in the bandwidth they can receive and/or transmit in for the purpose of reducing the UE's complexity, power consumption and/or cost. Furthermore, configuration B is beneficial in cases where the transmitting node, e.g., a gNB, uses analog transmit beamforming, resulting in that it can only transmit using one beam configuration, e.g. one beam direction in a beam sweep, at any one time. This means that parts of the frequency band, e.g. subcarriers, which are not utilized by the SSB (and possible PDSCH_{SIB}) transmission can only be used for transmissions in the same direction, e.g. opportunistically transmitting data to a UE which both happens to have pending downlink data and happens to be located in the coverage of the SSB(+PDSCH_{SIB}) beam. In practice, this would mean that the parts of the frequency band, e.g. subcarriers, which are not utilized by the SSB (and possible PDSCH_{SIB}) transmission are wasted most of the times. Distributing the SSB and PDSCH_{SIB} transmissions in time, i.e. TDM transmission style as in Configuration A, would then result in more radio transmission resources being wasted and Configuration B would clearly be a better choice from the resource usage/efficiency perspective.

The following is an illustrative example of how PSS indications of Configuration A or Configuration B as of FIG. 7 may be used. In the example two PSS sequences are used, one to indicate FDM style transmission (i.e. Configuration B) and one to indicate

TDM style transmission (i.e. Configuration A). These could then be mixed in the network and even in the same cell. For instance, even a cell using analog downlink transmission (DL TX) beamforming could use the FDM style transmission (Configuration B) for most of the transmissions, but now and then perform a less resource efficient TDM style transmission (Configuration A), to give narrowband UEs a chance to access the cell. A narrowband UE would only scan for the PSS associated with TDM style transmission (Configuration A) while a wideband UE could choose to either scan for both PSSs or only the PSS associated with FDM style transmission (Configuration B). Alternatively, a cell using digital DL TX beamforming could be configured to use only the TDM style transmission (Configuration A).

Other embodiments of NW access signalling configuration may include
Configuration of SSS, PBCH with regard to the PSS, e.g. their distance from PSS in number of OFDM symbols
Configuration of PBCH, e.g. single-symbol, dual equal symbols, or dual different symbols
Configuration of PBCH and/or PDSCH_{SIB} in relation to PSS/SSS, e.g. asymmetric FDM transmission, meaning that the PBCH and/or PDSCH_{SIB} occupy a wider frequency range on one side of the PSS/SSS than on the other side or even completely on one of the sides, e.g. in cases where the PSS/SSS do not occupy the centre frequencies of the utilized frequency band.
Other SSB configuration parameters.
quasi-co-location (QCL) of PSS and other parts of SSB (or not)—used to distinguish single frequency network (SFN) or conventional transmission of PSS
TSS configuration—location of TSS resource elements (REs) with regard to the PSS
Whether SSB are transmitted isotropically and repeated in time or beamformed and swept over multiple directions
Whether the SSB is transmitted in a beam with a first width and repeated in time or in a beam with a second width and swept over multiple directions, wherein the first width is wider than the second width
Whether SSB transmissions may be soft-combined or not, e.g. consecutive SSB transmissions with the same PSS may be soft-combined, but SSB transmissions with different PSS may not be soft-combined, and non-consecutive SSB transmissions with the same PSS, but with SSB transmission(s) with another PSS in between, may not be soft-combined.
Whether the PDSCH_{SIB} will be transmitted in conjunction with the SSB or not. This may be useful for a UE, which is informed of whether it should try to decode the PDSCH_{SIB} or not. A special case of this application may be operation in unlicensed spectrum. In such scenarios, it is preferable to transmit the SSBs (with accompanying PDSCH_{SIB}) back to back, e.g. in bursts. Every time there is a gap in the transmission, the gNB has to apply the Listen-Before-Talk (LBT) mechanism to verify that the channel is unoccupied before resuming transmission. If the back-to-back transmission principle is used, the gNB can keep the channel without inserting LBT procedures, which is favourable. In such scenarios, lack of transmission of the PDSCH_{SIB} in conjunction with the SSB (in TDM fashion) may not only be indicated by the PSS, but the absent PDSCH_{SIB} may also optionally be replaced by a dummy transmission to allow the gNB to keep the channel and avoid LBT.
A variation of the above usage of PSS to indicate presence or absence of the PDSCH_{SIB} in conjunction with the SSB transmission could be that the PSS indicates that SSB transmissions with and without accompanying PDSCH_{SIB} transmissions are mixed according to a predetermined pattern, e.g. that the PDSCH_{SIB} is present in conjunction with every second SSB or together with two consecutive SSBs followed by an SSB without PDSCH_{SIB} followed by two consecutive SSBs with PDSCH_{SIB} etc.

Preferably, the information embedded in PSS sequence selection is mainly usable prior to PBCH detection since any subsequent information is more efficiently obtained from the PBCH. The early awareness of the information embedded in the PSS sequence may be helpful in efficiently obtaining the information in e.g. the PBCH. For example, additional information about a network configuration is provided in a master information block, MIB, holding the network configuration, wherein the sequence selected for the PSS includes information about allocation of the MIB.

The examples given above in the context of PSS and other signals related to network access signalling configuration are given for the easier understanding. The suggested approach is equally feasible and usable for other synchronisation signals which may be adapted to contain additional network access signalling configuration information. For example, Active Mode Mobility (AMM) measurement signals or paging signals may be used in a similar way, but with other configurations in question.

FIG. 8 is a block diagram schematically illustrating a UE 700 according to an embodiment. The UE comprises an antenna arrangement 702, a receiver 704 connected to the antenna arrangement 702, a transmitter 706 connected to the antenna arrangement 702, a processing element 708 which may comprise one or more circuits, one or more input interfaces 710 and one or more output interfaces 712. The interfaces 710, 712 can be user interfaces and/or signal interfaces, e.g. electrical or optical. The UE 700 is arranged to operate in a cellular communication network. In particular, by the processing element 708 being arranged to perform the embodiments demonstrated above, the UE 700 is capable of acquiring early information from an initial synchronisation signal about network access signalling configuration, and is thereby better suited to receive further signalling including such signalling providing further system information. The UE is therefore suited to handle initial access with less effort. The processing element 708 can also fulfil a multitude of tasks, ranging from signal processing to enable reception and transmission since it is connected to the receiver 704 and transmitter 706, executing applications, controlling the interfaces 710, 712, etc.

The UE aspect, considering the corresponding example for the network node above, may include that the UE 700 in a first step searches for one or more PSS sequence(s) and detects and decodes the PSS. Having determined a likely PSS sequence, the UE 700 takes an action related to the sequence. In one embodiment, if the sequence implies FDM of the PDSCH_{SIB}, such an action may be to configure a wider bandwidth, in order to detect the PDSCH_{SIB} simultaneously as remaining synchronisation is performed. Having changed UE configuration, the UE 700 continues with its initial access and/or cell search procedure. In another embodiment, PSS conveys possible averaging schemes for further initial access or cell search processing, in which case the UE 700, having determined the PSS sequence, may make the necessary configurations for proper averaging, in order to improve signal-to-noise ratio (SNR). Further embodiments may be derived from the list of possible NW access signalling configurations that may be conveyed in the PSS. For example, the sequence selected for the PSS includes information about at least one of configuration of the SSS and the PBCH in relation to the PSS, configuration of the PBCH, configuration of system information on a physical downlink shared channel, PDSCH_{SIB}, configuration of another channel carrying system information, allocation of transmission resources for the another channel carrying system information, indication of whether different instances of synchronisation signal transmissions may be soft-combined, further SSB parameters, quasi-co-location of transmission points of the PSS and other parts of the SSB, TSS allocation related to the PSS, SSB transmissions, including whether the SSB is transmitted isotropically and repeated in time or beam formed and swept over multiple directions or whether the SSB is transmitted in a beam with a first width and repeated in time or in a beam with a second width and swept over multiple directions, wherein the first width is wider than the second width, bandwidth of SSB, time division properties of SSB, frequency division properties of SSB, etc.

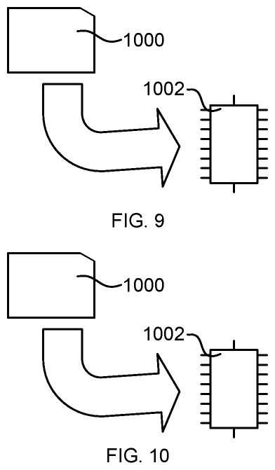

The methods of the wireless device according to the present disclosure are suitable for implementation with the aid of processing means, such as computers and/or processors, especially for the case where the processing element 708 demonstrated above comprises a processor of a wireless communication device handling initial access and cell search. Therefore, there is provided computer programs, comprising instructions arranged to cause the processing means, processor, or computer to perform the steps of any of the methods according to any of the embodiments described above. The computer programs preferably comprise program code which is stored on a computer readable medium 800, as illustrated in FIG. 9, which can be loaded and executed by a processing means, processor, or computer 802 to cause it to perform the methods, respectively, according to embodiments of the present disclosure, preferably as any of the embodiments described above. The computer 802 and computer program product 800 can be arranged to execute the program code sequentially where actions of the any of the methods are performed stepwise. The processing means, processor, or computer 802 is preferably what normally is referred to as an embedded system. Thus, the depicted computer readable medium 800 and computer 802 in FIG. 9 should be construed to be for illustrative purposes only to provide understanding of the principle, and not to be construed as any direct illustration of the elements.

The methods of the network node according to the present disclosure are suitable for implementation with aid of processing means, such as computers and/or processors, especially for the case where the processing element 1002 demonstrated below comprises a processor of a network node arranged for facilitating initial access and cell search. Therefore, there is provided computer programs, comprising instructions arranged to cause the processing means, processor, or computer to perform the steps of any of the methods according to any of the embodiments described above. The computer programs preferably comprise program code which is stored on a computer readable medium 900, as illustrated in FIG. 10, which can be loaded and executed by a processing means, processor, or computer 902 to cause it to perform the methods, respectively, according to embodiments of the present disclosure, preferably as any of the embodiments described above. The computer 902 and computer program product 900 can be arranged to execute the program code sequentially where actions of the any of the methods are performed stepwise. The processing means, processor, or computer 902 is preferably what normally is referred to as an embedded system. Thus, the depicted computer readable medium 900 and computer 902 in FIG. 10 should be construed to be for illustrative purposes only to provide understanding of the principle, and not to be construed as any direct illustration of the elements.

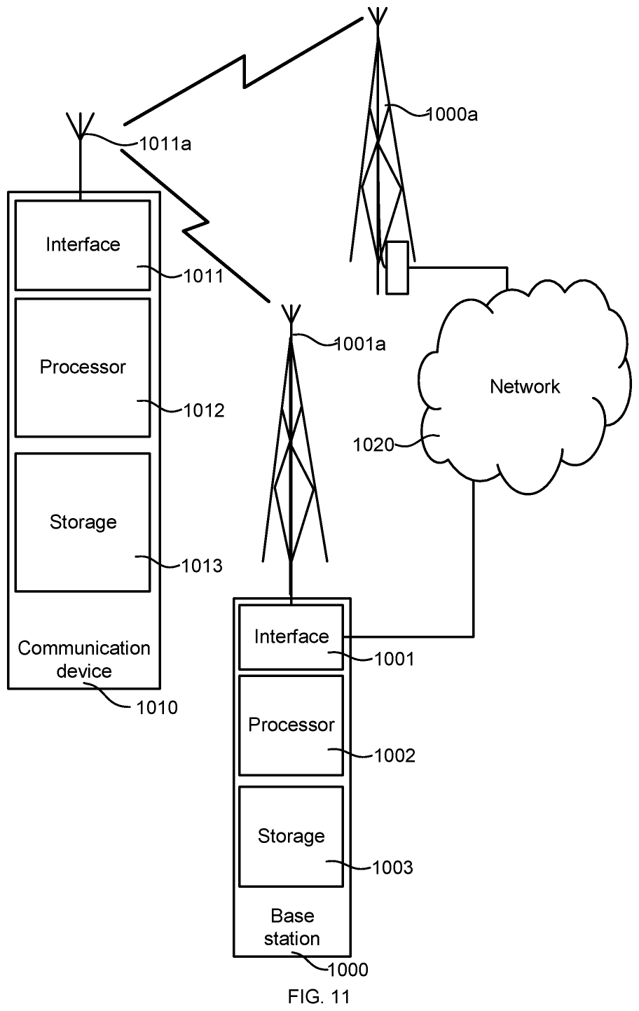

FIG. 11 illustrates a wireless network comprising NW nodes 1000 and 1000a and a wireless device 1010 with a more detailed view of the network node 1000 and the communication device 1010 in accordance with an embodiment. For simplicity, FIG. 11 only depicts core network 1020, network nodes 1000 and 1000a, and communication device 1010. Network node 1000 comprises a processor 1002, storage 1003, interface 1001, and antenna 1001a. Similarly, the communication device 1010 comprises a processor 1012, storage 1013, interface 1011 and antenna 1011a. These components may work together in order to provide network node and/or wireless device functionality as demonstrated above. In different embodiments, the wireless network may comprise any number of wired or wireless networks, network nodes, base stations, controllers, wireless devices, relay stations, and/or any other components that may facilitate or participate in the communication of data and/or signals whether via wired or wireless connections.

The network 1020 may comprise one or more IP networks, public switched telephone networks (PSTNs), packet data networks, optical networks, wide area networks (WANs), local area networks (LANs), wireless local area networks (WLANs), public land mobile networks (PLMNs), wired networks, wireless networks, metropolitan area networks, and other networks to enable communication between devices. The network 1020 may comprise a network node for performing the method demonstrated with reference to FIG. 4, and/or an interface for signalling between network nodes 1000, 1000a.

The network node 1000 comprises a processor 1002, storage 1003, interface 1001, and antenna 1001a. These components are depicted as single boxes located within a single larger box. In practice however, a network node may comprise multiple different physical components that make up a single illustrated component (e.g., interface 1001 may comprise terminals for coupling wires for a wired connection and a radio transceiver for a wireless connection). Similarly, network node 1000 may be composed of multiple physically separate components (e.g., a NodeB component and a radio network controller (RNC) component, a base transceiver station (BTS) component and a base station controller (BSC) component, etc.), which may each have their own respective processor, storage, and interface components. In certain scenarios in which network node 1000 comprises multiple separate components (e.g., BTS and BSC components), one or more of the separate components may be shared among several network nodes. For example, a single RNC may control multiple NodeB's. In such a scenario, each unique NodeB and BSC pair, may be a separate network node. In some embodiments, network node 1000 may be configured to support multiple radio access technologies (RATs). In such embodiments, some components may be duplicated (e.g., separate storage 1003 for the different RATs) and some components may be reused (e.g., the same antenna 1001a may be shared by the RATs).

The processor 1002 may be a combination of one or more of a microprocessor, controller, microcontroller, central processing unit, digital signal processor, application specific integrated circuit, field programmable gate array, or any other suitable computing device, resource, or combination of hardware, software and/or encoded logic operable to provide, either alone or in conjunction with other network node 1000 components, such as storage 1003, network node 1000 functionality. For example, processor 1002 may execute instructions stored in storage 1003. Such functionality may include providing various wireless features discussed herein to a wireless communication device, such as the wireless device 1010, including any of the features or benefits disclosed herein.

Storage 1003 may comprise any form of volatile or non-volatile computer readable memory including, without limitation, persistent storage, solid state memory, remotely mounted memory, magnetic media, optical media, random access memory (RAM), read-only memory (ROM), removable media, or any other suitable local or remote memory component. Storage 1003 may store any suitable instructions, data or information, including software and encoded logic, utilized by the network node 1000. the storage 1003 may be used to store any calculations made by the processor 1002 and/or any data received via the interface 1001.

The network node 1000 also comprises the interface 1001 which may be used in the wired or wireless communication of signalling and/or data between network node 1000, network 1020, and/or wireless device 1010. For example, the interface 1001 may perform any formatting, coding, or translating that may be needed to allow network node 1000 to send and receive data from the network 1020 over a wired connection. The interface 1001 may also include a radio transmitter and/or receiver that may be coupled to or a part of the antenna 1001a. The radio may receive digital data that is to be sent out to other network nodes or wireless devices via a wireless connection. The radio may convert the digital data into a radio signal having the appropriate channel and bandwidth parameters. The radio signal may then be transmitted via antenna 1001a to the appropriate recipient (e.g., the wireless device 1010).

The antenna 1001a may be any type of antenna capable of transmitting and receiving data and/or signals wirelessly. In some embodiments, antenna 1001a may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. The antenna 1001a may comprise one or more elements for enabling different ranks of SIMO, MISO or MIMO operation, or beamforming operations.

The wireless device 1010 may be any type of communication device, wireless device, UE, D2D device or ProSe UE, but may in general be any device, sensor, smart phone, modem, laptop, Personal Digital Assistant (PDA), tablet, mobile terminal, smart phone, laptop embedded equipped (LEE), laptop mounted equipment (LME), Universal Serial Bus (USB) dongles, machine type UE, UE capable of machine to machine (M2M) communication, etc., which is able to wirelessly send and receive data and/or signals to and from a network node, such as network node 1000 and/or other wireless devices. The wireless device 1010 comprises a processor 1012, storage 1013, interface 1011, and antenna 1011a. Like the network node 1000, the components of the wireless device 1010 are depicted as single boxes located within a single larger box, however in practice a wireless device may comprises multiple different physical components that make up a single illustrated component (e.g., storage 1013 may comprise multiple discrete microchips, each microchip representing a portion of the total storage capacity).

The processor 1012 may be a combination of one or more of a microprocessor, controller, microcontroller, central processing unit, digital signal processor, application specific integrated circuit, field programmable gate array, or any other suitable computing device, resource, or combination of hardware, software and/or encoded logic operable to provide, either alone or in combination with other wireless device 1010 components, such as storage 1013, wireless device 1010 functionality. Such functionality may include providing various wireless features discussed herein, including any of the features or benefits disclosed herein.

The storage 1013 may be any form of volatile or non-volatile memory including, without limitation, persistent storage, solid state memory, remotely mounted memory, magnetic media, optical media, random access memory (RAM), read-only memory (ROM), removable media, or any other suitable local or remote memory component. The storage 1013 may store any suitable data, instructions, or information, including software and encoded logic, utilized by the wireless device 1010. The storage 1013 may be used to store any calculations made by the processor 1012 and/or any data received via the interface 1011.

The interface 1011 may be used in the wireless communication of signalling and/or data between the wireless device 1010 and the network nodes 1000, 1000a. For example, the interface 1011 may perform any formatting, coding, or translating that may be needed to allow the wireless device 1010 to send and receive data to/from the network nodes 1000, 1000a over a wireless connection. The interface 1011 may also include a radio transmitter and/or receiver that may be coupled to or a part of the antenna 1011a. The radio may receive digital data that is to be sent out to e.g. the network node 1001 via a wireless connection. The radio may convert the digital data into a radio signal having the appropriate channel and bandwidth parameters. The radio signal may then be transmitted via the antenna 1011a to e.g. the network node 1000.

The antenna 1011a may be any type of antenna capable of transmitting and receiving data and/or signals wirelessly. In some embodiments, antenna 1011a may comprise one or more omni-directional, sector or panel antennas operable to transmit/receive radio signals between 2 GHz and 66 GHz. For simplicity, antenna 1011a may be considered a part of interface 1011 to the extent that a wireless signal is being used. The antenna 1011a may comprise one or more elements for enabling different ranks of SIMO, MISO or MIMO operation, or beamforming operations.

In some embodiments, the components described above may be used to implement one or more functional modules used for enabling measurements as demonstrated above. The functional modules may comprise software, computer programs, sub-routines, libraries, source code, or any other form of executable instructions that are run by, for example, a processor. In general terms, each functional module may be implemented in hardware and/or in software. Preferably, one or more or all functional modules may be implemented by the processors 1012 and/or 1002, possibly in cooperation with the storage 1013 and/or 1003. The processors 1012 and/or 1002 and the storage 1013 and/or 1003 may thus be arranged to allow the processors 1012 and/or 1002 to fetch instructions from the storage 1013 and/or 1003 and execute the fetched instructions to allow the respective functional module to perform any features or functions disclosed herein. The modules may further be configured to perform other functions or steps not explicitly described herein but which would be within the knowledge of a person skilled in the art.

Certain aspects of the proposed concepts have mainly been described above with reference to a few embodiments. However, as is readily appreciated by a person skilled in the art, embodiments other than the ones disclosed above are equally possible and within the scope of the proposed concepts. Similarly, while a number of different combinations have been discussed, all possible combinations have not been disclosed. One skilled in the art would appreciate that other combinations exist and are within the scope of the proposed concepts. Moreover, as is understood by the skilled person, the herein disclosed embodiments are as such applicable also to other standards and communication systems and any feature from a particular figure disclosed in connection with other features may be applicable to any other figure and or combined with different features.

1. A method in a network node of a cellular communication system, the cellular communication system being constructively arranged for co-existence of multiple network access signalling configurations, the method comprising:
collecting information about a network access signalling configuration;
selecting a low autocorrelation sequence based on the network access signalling configuration;
forming a synchronisation signal based on the low autocorrelation sequence; and
transmitting the synchronisation signal as a part of a system network access signalling transmission.

2. The method of claim 1, wherein the information about the network access signalling configuration comprises information enabling a wireless device to access at least one of the network node and the cellular communication system.

3. The method of claim 1, wherein the network access signalling configuration comprises configuration of at least one synchronisation signal.

4. The method of claim 1, wherein the at least one synchronisation signal is constructively configured to convey system information by being based on the information about the network access signalling configuration.

5. The method of claim 1, wherein the system network access signalling transmission includes a synchronisation signal block, SSB.

6. The method of claim 5, wherein the synchronisation signal forms a primary synchronisation signal, PSS, of the SSB which further comprises a secondary synchronisation signal, SSS, a tertiary synchronisation signal, TSS, and a physical broadcast channel, PBCH, signal.

7. The method of claim 6, wherein additional information about a network configuration is provided in a master information block, MIB, holding the network configuration, wherein the sequence selected for the PSS includes information about allocation of the MIB.

8. The method of claim 6, wherein the sequence selected for the PSS includes information about at least one of:
configuration of the SSS and the PBCH in relation to the PSS;
configuration of the PBCH;
configuration of system information on a physical downlink shared channel, PDSCH_{SIB};
configuration of another channel carrying system information;
allocation of transmission resources for the another channel carrying system information;
indication of whether different instances of synchronisation signal transmissions may be soft-combined;
further SSB parameters;
quasi-co-location of transmission points of the PSS and other parts of the SSB;
TSS allocation related to the PSS;
SSB transmissions, including whether the SSB is transmitted in a beam with a first width and repeated in time or in a beam with a second width and swept over multiple directions, wherein the first width is wider than the second width;
bandwidth of SSB;
time division properties of SSB; and
frequency division properties of SSB.

9. A network node configured to operate in a cellular communication system, the cellular communication system being constructively arranged for co-existence of multiple network access signalling configurations, the network node comprising a controller and a transceiver, the controller being configured to:
collect information about a network access signalling configuration;
select a low autocorrelation sequence based on the network access signalling configuration; and
form a synchronisation signal based on the low autocorrelation sequence, and
the transceiver being configured to transmit the synchronisation signal as a part of a system network access signalling transmission.

10. The network node of claim 9, wherein the information about the network access signalling configuration comprises information enabling a wireless device to access at least one of the network node and the cellular communication system.

11. The network node of claim 9, wherein the network access signalling configuration comprises a configuration of at least one more synchronisation signal.

12. The network node of claim 9, wherein the synchronisation signal is constructively configured to convey system information by being based on the information about the network access signalling configuration.

13. The network node of claim 9, wherein the system network access signalling transmission includes a synchronisation signal block, SSB.

14. The network node of claim 13, wherein the synchronisation signal comprises a primary synchronisation signal, PSS, of the SSB which further comprises a secondary synchronisation signal, SSS, a tertiary synchronisation signal, TSS, and a physical broadcast channel, PBCH, signal.

15. The network node of claim 14, wherein additional information about a network configuration is provided in a master information block, MIB, holding the network configuration, wherein the sequence selected for the PSS includes information about allocation of the MIB.

16. The network node of claim 14, wherein the sequence selected for the PSS includes information about at least one of
configuration of the SSS and the PBCH in relation to the PSS;
configuration of the PBCH;
configuration of system information on a physical downlink shared channel, PDSCH_{SIB};
configuration of another channel carrying system information,
allocation of transmission resources for the another channel carrying system information;
indication of whether different instances of synchronisation signal transmissions may be soft-combined;
further SSB parameters;
quasi-co-location of transmission points of the PSS and other parts of the SSB;
TSS allocation related to the PSS;
SSB transmissions, including whether the SSB is transmitted in a beam with a first width and repeated in time or in a beam with a second width and swept over multiple directions, wherein the first width is wider than the second width;
bandwidth of SSB;
time division properties of SSB; and frequency division properties of SSB.

17. (canceled)

18. A method of a wireless communication device configured to operate in a cellular communication network, the cellular communication system being constructively arranged for co-existence of multiple network access signalling configurations, the method comprising:
receiving a synchronisation signal;
determining, from a sequence of the synchronisation signal, information about synchronisation and a network access signalling configuration; and
adapting reception of further signals to the determined network access signalling configuration.

19. The method of claim 18, wherein the adapting of the reception comprises at least one of:
adapting receiver bandwidth;
adapting reception window;
adapting receiver frequency;
adapting transform properties of a receiver;
adapting averaging of received signals;
adapting antenna port use of the receiver; and
adapting resource mapping of subsequent signals and channels, including at least one of time, frequency, polarization, cyclic shift and code resources.

20. The method of claim 18, wherein the sequence is a low autocorrelation sequence.

21. The method of claim 18, wherein the information about the network access signalling configuration comprises information enabling the wireless communication device to access at least one of the network node and the cellular communication system.

22. The method of claim 21, wherein the network access signalling configuration comprises configuration at least one synchronisation signal.

23. The method of claim 18, wherein the synchronisation signal is constructively configured to convey system information by being based on the network access signalling configuration.

24. The method of claim 18, wherein the synchronisation signal is a primary synchronisation signal, PSS, of a synchronisation signal block, SSB.

25. The method of claim 24, wherein the SSB further comprises a secondary synchronisation signal, SSS, a tertiary synchronisation signal, TSS, and a physical broadcast channel, PBCH, signal.

26. The method of claim 18, wherein the information about the network access signalling configuration includes information about at least one of
configuration of the SSS and the PBCH in relation to the PSS;
configuration of the PBCH;
configuration of system information on a physical downlink shared channel, PDSCH_{SIB};
configuration of another channel carrying system information;
allocation of transmission resources for the another channel carrying system information;
indication of whether different instances of synchronisation signal transmissions may be soft-combined;
further SSB parameters;
quasi-co-location of transmission points of the PSS and other parts of the SSB;
TSS allocation related to the PSS;
SSB transmissions, including whether the SSB is transmitted in a beam with a first width and repeated in time or in a beam with a second width and swept over multiple directions, wherein the first width is wider than the second width;
operation in licensed or unlicensed band;
bandwidth of SSB;
time division properties of SSB; and
frequency division properties of SSB.

27. A wireless communication device configured to operate in a cellular communication network, the cellular communication system being constructively arranged for co-existence of multiple network access signalling configurations, the wireless communication device comprising a transceiver and a controller, the transceiver being configured to receive a synchronisation signal; and
the controller being configured to:
determine, from a sequence of the synchronisation signal, information about synchronisation and a network access signalling configuration; and
adapt reception of further signals to the determined network access signalling configuration.

28. The wireless communication device of claim 27, wherein the adaptation of the reception comprises at least one of:
adaptation of receiver bandwidth;
adaptation of reception window;
adaptation of receiver frequency;
adaptation of transform properties of a receiver;
adaptation of averaging of received signals;
adaptation of antenna port use of the receiver; and
adaptation of resource mapping of subsequent signals and channels, including at least one of time, frequency, polarization, cyclic shift and code resources.

29. The wireless communication device of claim 27, wherein the sequence is a low autocorrelation sequence.

30. The wireless communication device of claim 27, wherein the information about the network access signalling configuration comprises information enabling the wireless communication device to at least one of the network node and the cellular communication system.

31. The wireless communication device of claim 27, wherein the network access signalling configuration comprises configuration of at least one synchronisation signal.

32. The method of claim 27, wherein the synchronisation signal is constructively configured to convey system information by being based on the network access signalling configuration.

33. The wireless communication device of claim 27, wherein the synchronisation signal is a primary synchronisation signal, PSS, of a synchronisation signal block, SSB.

34. The wireless communication device of claim 33, wherein the SSB further comprises a secondary synchronisation signal, SSS, a tertiary synchronisation signal, TSS, and a physical broadcast channel, PBCH, signal.

35. The wireless communication device of claim 27, wherein the information about the network access signalling configuration includes information about at least one of:
configuration of the SSS and the PBCH in relation to the PSS;
configuration of the PBCH;
configuration of system information on a physical downlink shared channel, PDSCH_{SIB};
configuration of another channel carrying system information;
allocation of transmission resources for the another channel carrying system information;
indication of whether different instances of synchronisation signal transmissions may be soft-combined;
further SSB parameters;
quasi-co-location of transmission points of the PSS and other parts of the SSB;
TSS allocation related to the PSS;
SSB transmissions, including whether the SSB is transmitted in a beam with a first width and repeated in time or in a beam with a second width and swept over multiple directions, wherein the first width is wider than the second width;
operation in licensed or unlicensed band;
bandwidth of SSB;
time division properties of SSB; and
frequency division properties of SSB.

36. (canceled)
